(19) United States
(12) Patent Application Publication
(10) Pub. No.: US 2025/0360692 A1
(43) Pub. Date: Nov. 27, 2025

(54) MULTILAYERED METALLIC MICROSTRUCTURE

(71) Applicant: Purdue Research Foundation, West Lafayette, IN (US)

(72) Inventors: Ainur Sabirova, West Lafayette, IN (US); Tiwei Wei, Lafayette, IN (US)

(73) Assignee: Purdue Research Foundation, West Lafayette, IN (US)

(21) Appl. No.: 19/216,091

(22) Filed: May 22, 2025

Related U.S. Application Data
(60) Provisional application No. 63/651,422, filed on May 24, 2024.

(51) Int. Cl. B32B 15/02; B32B 15/20

(52) U.S. Cl. CPC B32B 15/02; B32B 15/20; B32B 2260/02; B32B 2260/046

(57) ABSTRACT

A method of fabricating a multilayered metallic microstructure includes stacking a plurality of porous membranes having various pore sizes and/or orientations, and joining the stacked plurality of porous membranes. The method further includes manufacturing the multilayered metallic microstructure as an integral microstructure formed by a plurality of nanowires defined in pores of the plurality of porous membranes.

This application claims priority to U.S. Provisional Application Ser. No. 63/651,422 entitled “Highly Dense and Uniform Copper Nanowires for Enhanced Multilayered Thermal Interface Material” filed May 24, 2024, the disclosure of which is incorporated herein by reference in its entirety.

### FIELD

This disclosure relates generally to metal microstructures, and, more particularly, to multilayered metallic microstructures.

### BACKGROUND

There exists longstanding interest in the development of multilayered micro- and nanostructures due to the ability of such micro- and nanostructures to impart advantageous material properties such as enhanced mechanical toughness, structural flexibility, reduced weight, and improved durability. Despite these advantages, however, scalable and reliable fabrication of such multilayered architectures, particularly in metallic systems, remains technically challenging.

Metallic multilayered composites, including those incorporating copper, are widely sought in advanced technologies such as electronic packaging, sensor arrays, and semiconductor components. Copper nanowires (CuNWs), in particular, exhibit favorable electrical, thermal, and mechanical characteristics, making them suitable for diverse applications including thermal management, optoelectronics, energy storage, catalysis, and related domains. The nanowire morphology contributes to high surface area-to-volume ratios and reduced photon scattering, which collectively enhance performance characteristics such as thermal conductivity.

Existing techniques for synthesizing CuNWs—such as template-assisted electrodeposition, hydrothermal processing, and chemical reduction methods—often require elevated temperatures, extended processing durations, or sophisticated instrumentation. Moreover, these conventional methods may yield inconsistent results due to limited control over nanowire dimensions, suboptimal yield, or the formation of undesirable byproducts, including copper oxides and nanoparticles, thereby complicating downstream integration into functional multilayered assemblies.

Accordingly, there remains a need for improved copper nanowire synthesis techniques that provide better control over morphology, higher production yields, and compatibility with scalable manufacturing. Methods that are also simplified, cost-effective, and environmentally sustainable, while delivering CuNWs with uniform and reproducible structural and compositional properties, would be advantageous.

### SUMMARY

In certain embodiments, the present disclosure provides a method for fabricating a multilayered metallic microstructure. The method comprises: stacking multiple porous membranes, wherein the membranes have differing pore sizes and/or orientations; bonding the stacked membranes together; and subsequently forming the multilayered metallic microstructure as an integrated structure composed of metal nanowires deposited or grown within the pores of the stacked membranes. This approach enables customizable architectural design of the metal microstructure and contributes to improved structural integrity and mechanical robustness.

In additional embodiments, the present disclosure is directed to a multilayered metallic microstructure comprising a plurality of discrete layers, each containing a network of metal nanowires. The configuration of each individual layer differs from that of its adjacent layers, and the multiple layers are integrally formed as a unified structure without distinct interfaces between them.

### BRIEF DESCRIPTION OF THE DRAWINGS

FIG. 1 is a perspective view of a multilayered metallic microstructure according to the disclosure.

FIG. 2 is a process diagram of a method for manufacturing a multilayered metallic microstructure according to the disclosure.

FIG. 3 depicts scanning electron microscope images of various membranes that can be used in the method of FIG. 2.

FIG. 4 is a graph of the membrane contact angle change resulting from the surface treatment of the membranes in the method of FIG. 2.

FIG. 5 is a side view of a plurality of membranes stacked on one another in the method of FIG. 2.

FIG. 6 is a graph of the bonding profile of several exemplary membrane stacks as a function of the number of layers in the membrane.

FIG. 7 is a graph of the electrochemical deposition profile of several exemplary membrane stacks as a function of the number of layers in the membrane.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

### Multilayered Microstructure

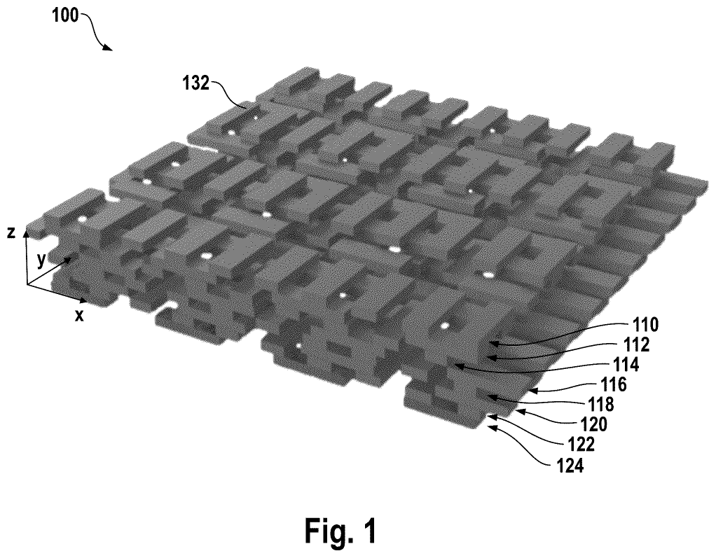

FIG. 1 depicts a multilayered metallic microstructure 100 formed of a plurality of layers 110, 112, 114, 116, 118, 120, 122, 124 of metallic nanowires 132 that are all integrally formed as a unitary structure. Each layer 110-124 includes a plurality of metallic nanowires 132 and is adjacent to, in particular in contact and integrally formed with, the nanowires of one or two adjacent layers 110-124 in the z-direction. Further, the nanowires 132 of each layer 110-124 are configured differently from at least the adjacent layer(s) 110-124. In particular, as used herein the layers being “configured differently” means at least one of the length, width, lengthwise spacing, and widthwise spacing of the individual nanowires differs such that the nanowires 132 of adjacent layers 110-124 are not aligned with one another in the x- and y-directions. In the illustrated embodiment, the nanowires 132 of the first, third, fifth, and seventh

layers 110, 114, 118, 122 are oriented with their longest dimension, i.e. length, extending in the y-direction, while the nanowires 132 of the second, fourth, sixth, and eighth layers 112, 116, 120, 124 are oriented with their longest dimension, i.e. length, extending in the x-direction such that the nanowires 132 of the first, third, fifth, and seventh layers 110, 114, 118, 122 are oriented perpendicularly or substantially perpendicularly to the nanowires 132 of the second, fourth, sixth, and eighth layers 112, 116, 120, 124. Further, in the illustrated embodiment, each of the layers 110-124 is configured as a planar, uniformly ordered array in which the nanowires 132 have a substantially uniform size and shape (i.e. within reasonable manufacturing tolerances) and are arranged in a plurality of rows aligned in both the x- and y-directions with substantially uniform spacing between the rows. As a result, the multilayered metallic microstructure 100 forms a complex network of interconnected and integrally formed nanowires 132.

The reader should appreciate that the number of layers 110-124 in the multilayered metallic microstructure 100 may vary depending on the desired use of the multilayered metallic microstructure 100. In addition, the configuration of the nanowires 132 within any particular layer 110-124 may vary depending on the desired use of the layer 110-124. For example, in various embodiments, none of the layers, one or more of the layers, or all of the layers are formed as uniformly ordered arrays, depending on the desired use of the multilayered metallic microstructure 100.

The metal nanowires 132 may be formed of, for example, copper, nickel, cobalt, silver, another desired metal, or alloys that include any of the aforementioned metals. In some embodiments, copper is used due to its high electrical conductivity, which is second only to silver among semiconductor metals, and relatively low cost compared to other semiconductor metals.

The nanowires 132 may be shaped differently and arranged in different orientations than shown in FIG. 1. For example, in some embodiments one or more layers may be formed with nanowires 132 having their longest dimension extending in the z-direction. Additionally, the nanowires 132 may be shaped with a circular, square, rectangular, oval, pentagonal, or hexagonal cross-section, with another polygonal or an irregular cross-section, or any combination of different cross-sectional shapes. The length and cross-sectional dimensions of the nanowires 123 may also vary in different embodiments. In some embodiments, for example, one or more layers may be formed of nanowires having a circular cross-section with a diameter in a range of from 50 nm to 5 μm and a length in a range of from 5 μm to 20 μm. In another embodiment, one or more layers may be formed of nanowires having a rectangular cross-section with a width in a range of from 100 nm to 5 μm, a thickness in a range of from 50 nm to 4 μm, and a length in a range of from 5 μm to 20 μm.

In various embodiments, the stacked layer configuration of the multilayered metallic microstructure 100 enables the incorporation of multiple functional capabilities within a single integrated system. The multilayer architecture may be implemented in, for example, biomedical devices, including but not limited to lab-on-a-chip platforms, implantable systems, and therapeutic scaffolds. In such applications, individual layers may be selectively configured for distinct purposes, such as the controlled release of chemical or pharmaceutical agents, the transmission or reception of electronic signals, or direct interaction with a target biological or chemical environment. In additional embodiments, the multilayer structure may be utilized in sensor technologies, including tactile or multifunctional sensing systems, wherein the distinct configuration of each layer enhances signal specificity and broadens the range of detectable stimuli. Certain layers may be tailored to selectively inhibit or modulate chemical or physical interactions, thereby providing protective or reversible operational behavior. Furthermore, the layered configuration contributes to structural resilience and mechanical integrity, particularly in use cases involving repetitive loading or environmental stress. The increased surface area resulting from the disclosed multilayer architecture is also advantageous in electrochemical systems, such as energy storage devices, by enabling multiple ion transport pathways and supporting improved charge and discharge kinetics.

### Microstructure Fabrication

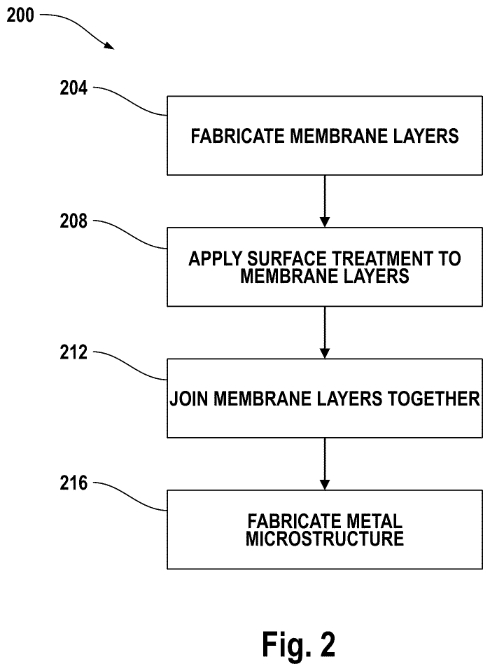

FIG. 2 depicts a process diagram of one method 200 for manufacturing a multilayered metallic microstructure such as the multilayered metallic microstructure 100 of FIG. 1. It is well-established that uniformity and symmetry are relevant parameters for certain fine-structured materials that can significantly influence both the fabrication process and the resulting material's properties. Uniform metal structures, in particular uniform copper structures, facilitate even distribution of applied energy, reducing localization or distortion. Regularity also ensures consistent metal growth during the electrochemical deposition process, avoiding incomplete filling. To produce such uniform micro-scaled metal arrangements in a leveled matrix, the method 200 includes a templating technique combined with electroplating copper growth, where a multilayered isoporous membrane is used for the templating.

The method 200 begins with fabrication of the membrane layers (block 204). The membrane fabrication includes forming multiple membrane layers that have different pore sizes or orientations. In particular, the membrane layers are isoporous membrane layers, in which one or more of the membrane layers, and in some embodiments all of the membrane layers, have a highly uniform and ordered pore structure. More specifically, the membrane fabrication (block 204) includes producing a plurality of membrane layers using a photolithography technique followed by an inductive-coupled plasma reactive ion etching (ICP-RIE) process. The membrane layers may be fabricated, for example, using the membrane fabrication process disclosed in US 2022/0143560, the entire disclosure of which is incorporated by reference herein in its entirety.

For example, the membrane layers may be formed by using lithography to deposit a polymer layer on a substrate, and then etching the pores into the polymer layer in the pattern of the desired pore structure. The membrane layers may be formed of a polymeric film, for example, poly (ethylene terephthalate) (PET), polyvinylidene fluoride, polyacrylonitrile, polyethylene, polypropylene, polycarbonate, polysulfone, polyethersulfone, polystyrene, polytetrafluoroethylene, epoxy, cellulose, poly-triazole, poly-oxadiazole, polyether, ether ketone, cross-linked polymers, acrylic polymers, polyurethanes, polyesters, any combination of the above, or any other desired membrane material.

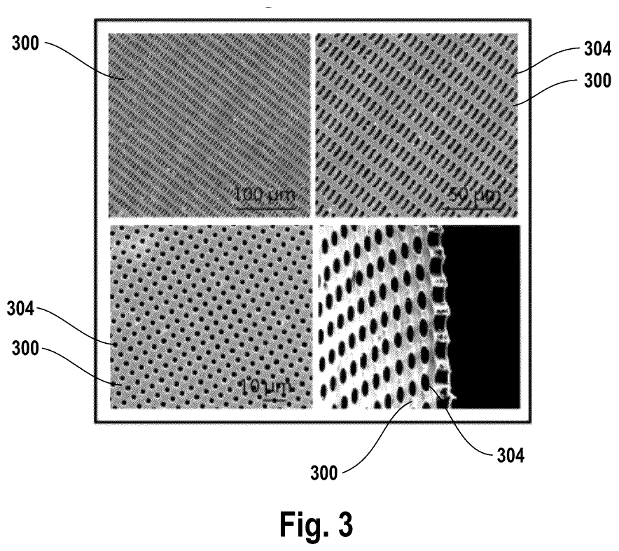

In some embodiments, the individually developed membrane layers have rectangular-shaped or circular-shaped pores, though the reader should appreciate that the pore shape may be adapted depending on the desired use of the microstructure. Further, in one particular embodiment, a membrane layer with rectangular pores may have a pore width of approximately 4 μm and a pore length of approximately 12 μm, or a membrane layer with circular pores may have a pore diameter of approximately 2 μm, with both having a membrane layer thickness of approximately 2.5 μm, resulting in a total porous surface area as large as 38 cm², and high porosity of approximately 20%. The reader should appreciate, however, that the aforementioned dimensions should not be considered limiting, as the pore dimensions and membrane layer thickness can be adapted depending on the specific desired use of the resulting microstructure. For illustrative purposes, FIG. 3 depicts several scanning electron microscope (SEM) images of examples of isoporous membrane layers 300 formed via the disclosed methods, and which have a plurality of pores 304.

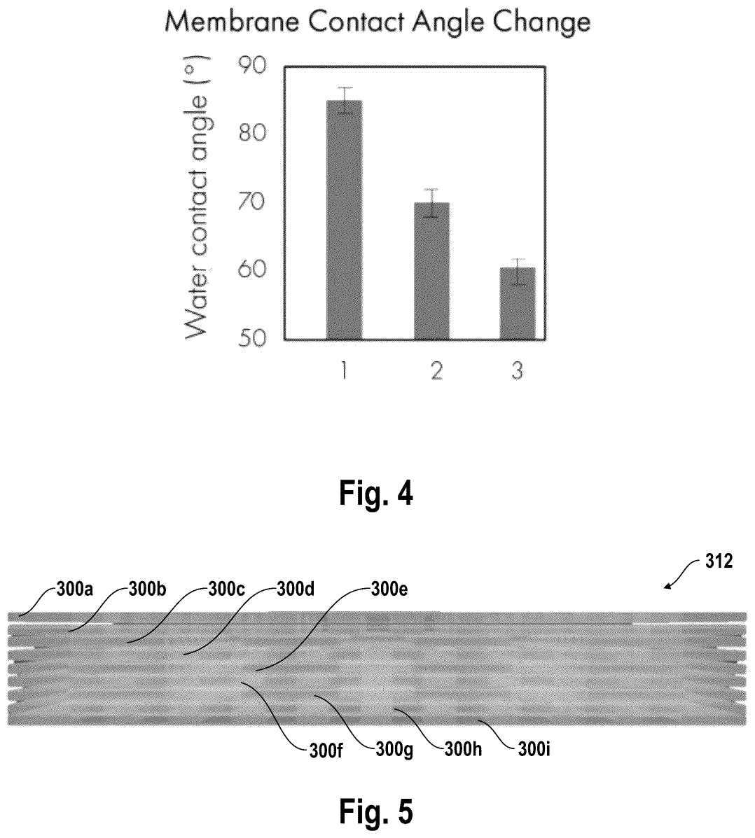

The method 200 continues with applying surface treatment to the membrane layers (block 208). In certain embodiments, isoporous membranes, including those composed of polyethylene terephthalate (PET), exhibit inherent hydrophobicity, as indicated by a water contact angle of approximately 90 degrees. To enhance the infiltration of aqueous electrolytes into the membrane pores and improve copper ion transport uniformity during electrochemical deposition—as well as to increase adhesion between adjacent membrane layers and the conductive substrate—it is advantageous to modify the membrane surfaces to exhibit hydrophilic characteristics. Accordingly, surface treatment of the membrane layers in block 208 may be performed to enhance wettability. In one embodiment, the surface treatment includes a two-step modification process involving exposure to oxygen plasma followed by application of a hydrophilic coating, such as polydopamine (PDA), via spray deposition. The oxygen plasma treatment introduces oxygen-containing functional groups (e.g., hydroxyl and carboxyl groups) onto the PET surface through ion bombardment and surface activation, thereby increasing hydrophilicity. Subsequently, the application of PDA forms a conformal coating via oxidative self-polymerization of dopamine under mildly alkaline conditions (e.g., pH approximately 8.8), resulting in a surface enriched with catechol and amine functionalities that exhibit strong interaction with the membrane substrate. As shown in FIG. 4, these combined treatments can, in certain embodiments, reduce the water contact angle from approximately 90 degrees to approximately 60 degrees, thereby enhancing pore wetting and electrolyte transport.

The method 200 further comprises bonding the plurality of previously formed membrane layers 300a-300i to generate a multilayered membrane structure 312, as illustrated in FIG. 5 (block 212). The bonding process includes stacking the membrane layers to achieve a predefined orientation and alignment of pores 304, followed by application of heat and pressure to form a mechanically stable composite. In one embodiment, bonding is performed using a flip-chip bonder apparatus that applies thermal energy and controlled mechanical force from both the upper and lower surfaces to facilitate uniform and precise interfacial adhesion. Considering the thermal properties of PET—including a glass transition temperature near 70° C., a melting point around 255° C., and degradation onset above 380° C.—the bonding process, in one embodiment using PET as the membrane material, may be conducted at, for example, a temperature in the range of approximately 100° C. to 140° C.

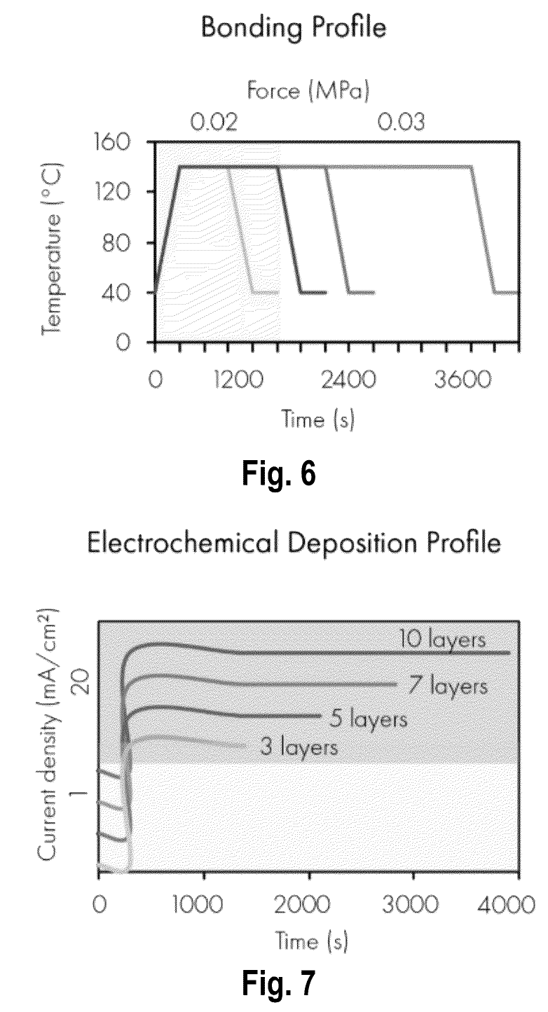

In additional embodiments, bonding parameters such as temperature, pressure, and dwell time may be selectively varied depending on material composition and the number of membrane layers being joined. FIG. 6 depicts exemplary force and temperature profiles corresponding to bonding processes for membrane stacks comprising three, five, seven, and ten layers. Furthermore, the presence of PDA coating on the membrane surfaces may contribute to enhanced bonding performance by promoting non-covalent interactions with adjacent layers due to its catechol and amine functional groups, which are known to interact strongly with both organic and inorganic substrates.

Following bonding, the method 200 includes fabrication of the metallic microstructure (block 216). In one embodiment, the metallic microstructure is formed within the multilayered membrane structure 312 using electrochemical deposition to grow or deposit a plurality of nanowires within the pores defined in the plurality of porous membranes. The membrane assembly is mounted on a conductive substrate coated with a seed layer of gold, which may be deposited via electron beam (e-beam) evaporation. The resulting system is then positioned within a plating holder and subjected to vacuum-assisted wetting to displace trapped air and ensure uniform electrolyte infiltration. In some embodiments, electroplating is conducted at ambient temperature using a copper-based electrolyte solution.

After metal deposition, the template membrane may optionally be removed, for example through chemical dissolution, resulting in a free-standing copper microstructure. Alternatively, in some embodiments, the template membrane is not removed, forming a hybrid metallic-polymeric structure that has both the high thermal conductivity of the metallic material in combination with the mechanical compliance of the polymeric membrane materials, enabling the microstructure to have both efficient heat transfer properties and low elastic modulus, specifically a lower elastic modulus than a metal alone.

In one implementation, the electroplating process includes an initial low-current pre-treatment step, followed by copper deposition at a higher current density, such as approximately 2 amperes per square decimeter (ASD). The total deposition duration may be selected based on the overall thickness of the multilayer template, which corresponds to the number of membrane layers utilized. An exemplary electrochemical deposition profile as a function of layer count is shown in FIG. 7.

The result of the electrochemical deposition process is a multilayered metallic microstructure composed of interconnected metal nanowires, for example CuNWs. In one embodiment, the fabricated structure corresponds to the multilayered metallic microstructure 100 illustrated in FIG. 1. Alternatively, the configuration may be tailored by modifying the geometry or arrangement of the membrane layers used as a template. The electrodeposition process enables the formation of an integrally structured multilayer architecture in which adjacent layers are metallurgically continuous, without the presence of discrete bonding interfaces. This integrated formation enhances mechanical robustness and reduces the likelihood of interfacial failure. Furthermore, the interlayer spacing within the microstructure enables reversible deformation, such as bending or flexing, without compromising structural integrity. This mechanical compliance renders the multilayer microstructure particularly suitable for applications involving flexible electronics, integrated circuits, and other advanced device platforms.

The disclosed fabrication process for forming multilayered hybrid metal microstructure composites addresses challenges associated with dimensional variation in external geometries of metal microstructures, as well as inconsistencies in internal features such as grain size and crystallographic orientation, which can adversely affect the electrical, mechanical, and thermal properties of the resulting materials. In particular, the formation of a continuous, single-growth metallic microstructure improves interfacial cohesion and mechanical integrity, offering superior performance compared to conventional approaches where individual metal layers are fabricated separately and subsequently bonded, often resulting in structural discontinuities at the interfaces.

Further, the disclosed multilayer fabrication methodology has broad applicability in advanced micro- and nanotechnologies, including but not limited to electronic cooling systems, thermal interface materials, and copper redistribution layers (RDL) integrated into multilayer substrates for advanced semiconductor packaging. In certain embodiments, the disclosed process is employed to construct multilayer porous metallic structures optimized for enhanced heat dissipation through two-phase convection-based liquid cooling mechanisms. The multilayered metallic microstructure 100 and corresponding fabrication method 200 may also be applied to form metallic thermal interface materials incorporating polymeric fillers within the porous metal network. Such hybrid structures leverage the high thermal conductivity of metallic materials, and in particular embodiments copper, in combination with the mechanical compliance of polymeric materials to achieve both efficient heat transfer and low elastic modulus. Moreover, the described technique may be utilized for the fabrication of three-dimensional RDL metal interconnects on silicon or glass substrates, serving as conductive pathways in semiconductor devices. Unlike traditional fabrication techniques, which typically involve repeated cycles of lithography, electroplating, and chemical-mechanical planarization (CMP) for each individual layer, the method 200 enables the streamlined production of integrated multilayer microstructures, thereby reducing process complexity, manufacturing costs, and environmental burden.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. A method of fabricating a multilayered metallic microstructure comprising:
stacking a plurality of porous membranes having various pore sizes and/or orientations;
joining the stacked plurality of porous membranes; and
forming the multilayered metallic microstructure as an integrated microstructure formed by a plurality of nanowires defined in pores of the plurality of porous membranes.

2. The method of claim 1, wherein the forming of the multilayered metallic microstructure includes growing the plurality of nanowires of the multilayered metallic microstructure in the pores via electrochemical deposition.

3. The method of claim 2, wherein the forming of the multilayered metallic microstructure includes forming each layer of the multilayered metallic microstructure as a discrete and uniformly ordered array of the plurality of nanowires.

4. The method of claim 3, wherein each of the plurality of porous membranes is an isoporous membrane.

5. The method of claim 4, wherein adjacent membranes of the plurality of membranes have pore structures that are configured differently from one another.

6. The method of claim 5, further comprising:
fabricating the plurality of porous membranes using an inductive-coupled plasma reactive ion etching process.

7. The method of claim 5, further comprising:
applying surface treatment to the plurality of membranes before stacking the plurality of porous membranes.

8. The method of claim 7, wherein the applying of the surface treatment comprises applying oxygen to the plurality of membranes by plasma treatment.

9. The method of claim 8, wherein the applying of the surface treatment further comprises spray coating the plurality of membranes with polydopamine.

10. The method of claim 2, wherein the joining of the membranes includes applying heat and pressure to the stacked plurality of membranes from upper and lower surfaces of the plurality of membranes to bond the plurality of membranes to one another.

11. The method of claim 2, wherein the electrochemical deposition includes using a copper-based solution to form the multilayered metallic microstructure of copper.

12. A metallic microstructure comprising:
a plurality of layers, each layer comprising a plurality of metal nanowires, each layer of the plurality of layers being configured differently than each adjacent layer of the plurality of layers,
wherein the plurality of layers are integrally formed with one another.

13. The metallic microstructure of claim 12, wherein each layer of the plurality of layers is formed as a uniformly ordered array of the plurality of metal nanowires.

14. The metallic microstructure of claim 13, wherein each layer of the plurality of layers is substantially planar.

15. The metallic microstructure of claim 14, wherein the plurality of metal nanowires of each layer of the plurality of layers is oriented substantially perpendicular to the plurality of metal nanowires of each adjacent layer of the plurality of metal nanowires.

16. The metallic microstructure of claim 12, further comprising a polymeric material arranged in spaces defined between the plurality of metal nanowires.

17. The metallic microstructure of claim 16, wherein the polymeric material fills the spaces between the plurality of metal nanowires of each layer of the plurality of layers.
